(19) United States
(12) Patent Application Publication
(10) Pub. No.: US 2020/0104710 A1
(43) Pub. Date: Apr. 2, 2020

(54) TRAINING MACHINE LEARNING MODELS USING ADAPTIVE TRANSFER LEARNING

(71) Applicant: Google LLC, Mountain View, CA (US)

(72) Inventors: Vijay Vasudevan, Los Altos Hills, CA (US); Ruoming Pang, New York, NY (US); Quoc V. Le, Sunnyvale, CA (US); Daiyi Peng, Cupertino, CA (US); Jiquan Ngiam, Mountain View, CA (US); Simon Kornblith, Toronto (CA)

(21) Appl. No.: 16/586,675

(22) Filed: Sep. 27, 2019

Related U.S. Application Data
(60) Provisional application No. 62/737,854, filed on Sep. 27, 2018.

(51) Int. Cl. G06N 3/08; G06N 3/04

(52) U.S. Cl. CPC G06N 3/08; G06N 3/0454

(57) ABSTRACT

A method for training a target neural network on a target machine learning task is described. The method includes: obtaining a target dataset for training the target neural network on the target machine learning task, the target dataset comprising a plurality of target training examples; obtaining a source dataset for training a source neural network on a source machine learning task, the source dataset comprising a plurality of source training examples; wherein each of the target neural network and the source neural network has the same feature neural network layers having feature layer parameters, the target neural network further comprises one or more target classification layers having target classification parameters, and the source neural network further comprises one or more source classification layers having source classification parameters; generating, from the source training examples in the source dataset, a pre-training dataset using the source dataset and the target dataset so that the pre-training dataset captures features that are relevant to the target dataset; training the source neural network on the source machine learning task using the pre-training dataset to obtain first values of the feature layer parameters and the source classification parameters; initializing the feature layer parameters of the target neural network using the first values of the feature layer parameters from the training of the source neural network; and training the target neural network on the target machine learning task using the target dataset to obtain trained values of the feature layer parameters and the target classification parameters.

### CROSS-REFERENCE TO RELATED APPLICATION

This application claims priority to U.S. Provisional Application Ser. No. 62/737,854, filed on Sep. 27, 2018. The disclosure of the prior application is considered part of and is incorporated by reference in the disclosure of this application.

### BACKGROUND

This specification relates to training machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that trains a target neural network on a target machine learning task using adaptive transfer learning.

The subject matter described in this specification can be implemented in particular embodiments so as to realize one or more of the following advantages. The training techniques described in this specification allow a system to train a target neural network on a very small dataset by leveraging the availability of a much larger but potentially not fully relevant source dataset to improve performance of the target neural network on a target machine learning task. In particular, the training techniques capture insights learned by a source neural network on the source dataset by assigning each of the source training label in the source dataset a respective weight corresponding to how important it is. These weights are computed by normalizing the distribution of predicted source labels for target training inputs. The training techniques therefore enable the system to select, from the source dataset, a pre-training dataset including source training examples that are most informative for the target machine learning task. By using the pre-training dataset, which has a much smaller size than the original source training set, to pre-train the parameters of feature neural network layers in the target neural network, the entire training process is more stable and thus quicker to converge. In addition, as the target neural network is able to learn features directly from a set of relevant source training examples in the pre-training dataset, the target neural network can achieve higher performance on the target machine learning task (compared to neural networks that are not pre-trained on a pre-training dataset selected from a source dataset).

The training techniques described is this specification are particularly useful in situations where it is difficult to obtain training data for a particular task but easy to obtain a larger set of training data that may be partially relevant to the particular task.

For example, the target neural network may be part of a computer-assisted medical diagnosis system. The training techniques described herein can leverage a generic image dataset to train the target neural network on a specific medical task, e.g., generating predicted treatments from images of a patient, when only a small medical image dataset can be obtained for the specific medical task. In some cases, the target neural network can be trained on a small disease or condition specific dataset by leveraging insights learned from a generic medical dataset.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an architecture of an example neural network system for training a target neural network on a target machine learning task using adaptive transfer learning.

FIG. 2 is a flow diagram of an example process for generating a pre-training dataset.

FIG. 3 is a flow diagram of an example process for training a target neural network on a target machine learning task using adaptive transfer learning.

Like reference numbers and designations in the various drawings indicate like elements.

### DETAILED DESCRIPTION

This specification describes a neural network system implemented as computer programs on one or more computers in one or more locations that trains a target neural network on a target machine learning task using adaptive transfer learning. In particular, the system can train the target neural network on a very small dataset by leveraging the availability of a much larger but potentially not fully relevant source dataset to improve performance of the target neural network on the target machine learning task.

For example, the target machine learning task may be a classification task, such as an image processing task, a speech recognition task, a natural language processing task, or an optical character recognition task. For instance, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

As another example, if the inputs to the target neural network, are Internet resources (e.g., web pages), documents, or portions of documents or features extracted from Internet resources, documents, or portions of documents, the task can be to classify the resource or document, i.e., the output generated by the machine learning model for a given Internet resource, document, or portion of a document may be a score for each of a set of topics, with each score representing an estimated likelihood that the Internet resource, document, or document portion is about the topic.

As another example, if the inputs to the target neural network are features of an impression context for a particular advertisement, the output generated by the target neural network may be a score that represents an estimated likelihood that the particular advertisement will be clicked on.

As another example, if the inputs to the target neural network are features of a personalized recommendation for a user, e.g., features characterizing the context for the recommendation, e.g., features characterizing previous actions taken by the user, the output generated by the target neural network may be a score for each of a set of content items, with each score representing an estimated likelihood that the user will respond favorably to being recommended the content item.

As another example, if the input to the target neural network is a sequence of text in one language, the output generated by the target neural network may be a score for each of a set of pieces of text in another language, with each score representing an estimated likelihood that the piece of text in the other language is a proper translation of the input text into the other language.

As another example, the task may be an audio processing task. For example, if the input to the target neural network is a sequence representing a spoken utterance, the output generated by the target neural network may be a score for each of a set of pieces of text, each score representing an estimated likelihood that the piece of text is the correct transcript for the utterance. As another example, if the input to the target neural network is a sequence representing a spoken utterance, the output generated by the target neural network can indicate whether a particular word or phrase (“hotword”) was spoken in the utterance. As another example, if the input to the target neural network is a sequence representing a spoken utterance, the output generated by the target neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

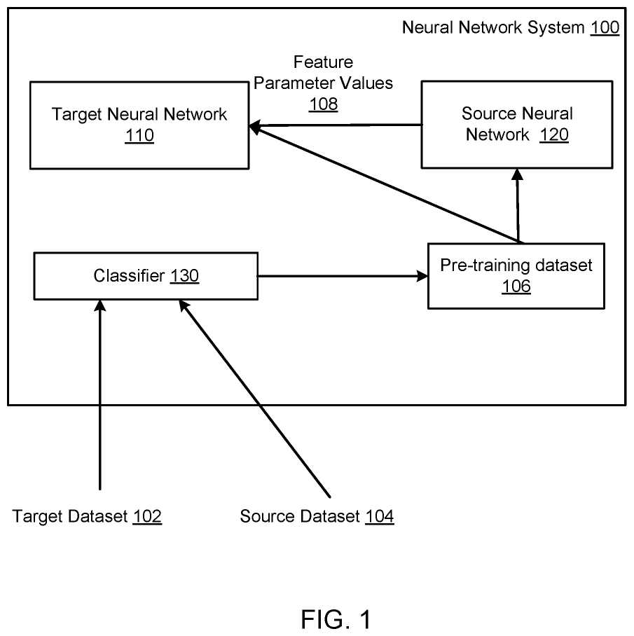

FIG. 1 shows an example neural network system 100. The system 100 is an example of a system implemented as computer programs on one or more computers in one or more locations, in which the systems, components, and techniques described below can be implemented.

The neural network system 100 includes a target neural network 110 and a source neural network 120. The target neural network 110 is configured to perform a target machine learning task while the source neural network 120 is configured to perform a source machine learning task. Generally, both of the source and target machine learning tasks are the same type of machine learning task, but the target machine learning task is more specific than the source machine learning task. For example, both of the source and target machine learning tasks are image classification, but the target machine learning task is to recognize whether an object in an image belongs to any of a plurality of vehicle categories (e.g., cars, bikes, or trucks), while the source machine learning task is to classify objects in the image into more general categories such vehicles, people, animals, and infrastructure. The image can be, for example, an image taken by a camera of a self-driving car or an image taken by a camera of a mobile phone.

In particular, the target neural network 110 and the source neural network 120 have the same feature neural network layers having feature layer parameters. The target neural network 110 further includes one or more target classification layers having target classification parameters, and the source neural network 120 further includes one or more source classification layers having source classification parameters.

During training, the system 100 obtains a target dataset 102, denoted as Dₜ, for training the target neural network 110 on the target machine learning task. The target dataset includes a plurality of target training examples. Each of the plurality of target training examples includes a target training input and a respective ground-truth target output.

The system 100 obtains a source dataset 104, denoted as Dₛ, for training the source neural network 120 on the source machine learning task. Generally, the source dataset 104 is much larger than the target dataset and is potentially not fully relevant to the target machine learning task. The source dataset 104 includes a plurality of source training examples. Each source training example in the source dataset includes a source training input and a respective ground-truth source output. The respective ground-truth source output belongs to a set of possible source outputs.

To improve performance of the target neural network 110 on the target machine learning task, the system 100 employs adaptive transfer learning techniques. Specifically, the system 100 generates, from the source dataset 104, a pre-training dataset 106 that captures features that are most relevant to the target dataset 102. The system 100 then pre-trains the source neural network 120 on the pre-training dataset. The system 100 transfers the insights learned by the source neural network 120 to the target neural network 110 by initializing the feature layer parameters of the target neural network 110 using trained values of the feature layer parameters of the source neural network 120. The system 100 then trains the target neural network 110 on the target dataset 102 to update both feature layer parameters and target classification parameters of the target neural network 110. By pre-training the target neural network 110 on the pre-training dataset that has a much smaller size than the source dataset, the entire process for training the target neural network 110 can be more stable, quicker to converge, and computationally efficient.

In particular, to generate a pre-training dataset 106, the system 100 considers to optimize a loss function over the target dataset Dₜ (102) as follows:

$${E}_{x , y ∼ {D}_{t}} [ L ( {f}_{θ} ( x ) , y ) ] = {\sum }_{x , y} {P}_{t} ( x , y ) L ( {f}_{θ} ( x ) , y ) , \qquad ( 1 )$$

where Pₜ denotes a distribution over the target dataset Dₜ (102). L(f_{θ}(x),y) is a cross entropy loss between predicted outputs f_{θ}(x) and ground-truth outputs y, where f_{θ}(·) represents the target neural network 110 and the source neural network 120 and θ represents the parameters of these networks. For simplicity, it is assumed that the source dataset 104 and the target dataset 102 are over the same set of values in inputs x and outputs y. This assumption will be relaxed later in this description.

The loss function in equation 1 can be reformulated to include the source dataset Dₛ as follows:

$$= {\sum }_{x , y} {P}_{s} ( x , y ) \frac{{P}_{t} ( x , y )}{{P}_{s} ( x , y )} L ( {f}_{θ} ( x ) , y ) = {\sum }_{x , y} {P}_{s} ( x , y ) \frac{{P}_{t} ( y ) {P}_{t} ( x \vert y )}{{P}_{s} ( y ) {P}_{s} ( x \vert y )} L ( {f}_{θ} ( x ) , y ) . \qquad ( 2 )$$

where Pₛ denotes a distribution over the source dataset Dₛ (104).

Assuming that the distribution of examples given a particular source output in the source dataset 104 is approximately the same as that of the target dataset 102, i.e., then the loss function in equation 2 can be simplified as follows:

$$\approx {\sum }_{x , y} {P}_{s} ( x , y ) \frac{{P}_{t} ( y )}{{P}_{s} ( y )} L ( {f}_{θ} ( x ) , y ) = {E}_{x , y ∼ {D}_{s}} [ \frac{{P}_{t} ( y )}{{P}_{s} ( y )} L ( {f}_{θ} ( x ) , y ) ] , \qquad ( 3 )$$

Intuitively, Pₜ(y) describes the distribution of outputs in the target dataset, and Pₜ(y)/Pₛ(y) reweights object classes during the pre-training of the source neural network 120 so that the class distribution statistics match P_{y}(t). Pₜ(y)/Pₛ(y) is referred to as an importance weight associated with a source output y.

To make the adaptive transfer learning approach applicable in practice, the earlier assumption that the source and target datasets share the same input and output space needs to be relaxed. The goal of the system 100 is to compute, for each source output y in the set of possible source outputs, a respective importance weight Pₜ(y)/Pₛ(y) that indicates the importance of the source output y in training the target neural network 110. To determine Pₛ(y), the system 100 determines a rate of appearance of the source output y in the source dataset Dₛ by dividing the number of times the source output y appears by the total number of source training examples in the source dataset Dₛ (104). A source output y appears in the source dataset when it appears in a ground truth output for an input in the source dataset.

To estimate Pₜ(y), the system 100 trains a classifier neural network 130 on the entire source dataset 104. The classifier neural network 130 is configured to receive an input and to generate for the input a respective output that belongs to the set of possible source outputs. The classifier neural network can be the same as the source neural network 120 or different from the source neural network 120.

The system 100 then feeds the target training inputs of the target training examples from the target dataset 102 into the trained classifier neural network 130. The trained classifier neural network 130 processes each of the target training inputs to generate a respective temporary predicted output for each target training example. The respective temporary predicted output for each target training example is selected from the set of possible source outputs. For each source output y in the set of possible source outputs, the system 100 determines Pₜ(y) that represents a rate of appearance of the source output y in the set of temporary predicted outputs that have been generated by the trained classifier neural network 130 for the target training inputs in the target dataset 102.

After computing Pₛ(y) and Pₜ(y) for each of the source outputs in the source dataset 104, the system 100 computes the importance weight Pₜ(y)/Pₛ(y) for each source output. It is noted that the system 100 does not use any target outputs in the target dataset 102 in the computation of importance weights.

The system 100 generates the pre-training dataset 106 by sampling a set of source training examples from the source dataset 104 based on the computed importance weights for the source outputs.

In some implementations, the set of source training examples is sampled from the source dataset 104 with replacement. When sampling with replacement, the system 100 samples source training examples at a rate proportional to the importance weights computed before, repeating examples as needed.

In some other implementations, the set of source training examples is sampled from the source dataset 104 without replacement. When sampling without replacement, the system 100 avoids selecting each example more than once.

After generating the pre-training dataset 106, the system 100 trains the source neural network 120 on the source machine learning task using the pre-training dataset 106 to obtain first values of the feature layer parameters and the source classification parameters of the source neural network 120. In particular, the system 100 adjusts values of the feature layer parameters and the source classification parameters to optimize a source objective function. The source objective function measures an average performance of the source neural network on the source machine learning task given the source training examples in the pre-training dataset. For example, the system 100 adjusts values of the feature layer parameters and the source classification parameters to minimize a loss function E_{x,y˜D}_{ₚᵣ}[L(f_{θ}(x), y)] that is computed empirically over the pre-training dataset denoted as Dₚᵣ.

To train the target neural network 110, the system 100 initializes the feature layer parameters of the target neural network 100 using the first values 108 of the feature layer parameters from the training of the source neural network 120.

The system 100 then trains the target neural network 110 on the target machine learning task using the target dataset to obtain trained values of the feature layer parameters and the target classification parameters of the target neural network 110. More specifically, the system 100 adjusts values of the feature layer parameters and the target classification parameters to optimize a target objective function. The target objective function measures an average performance of the target neural network 110 on the target machine learning task given the target training examples in the target dataset. For example, the system 100 adjusts values of the feature layer parameters and the target classification parameters to minimize a loss function E_{x,y˜D}_{ₜ}[L(f_{θ}(x),y)] that is computed empirically over the source dataset Dₜ.

After training, in some cases, the system 100 may use the trained target neural network 110 to process a new input to generate a new output. In some other cases, the system 110 may provide data specifying the trained target neural network 110 to another system that uses the trained target neural network 110 to process a new input to generate a new output.

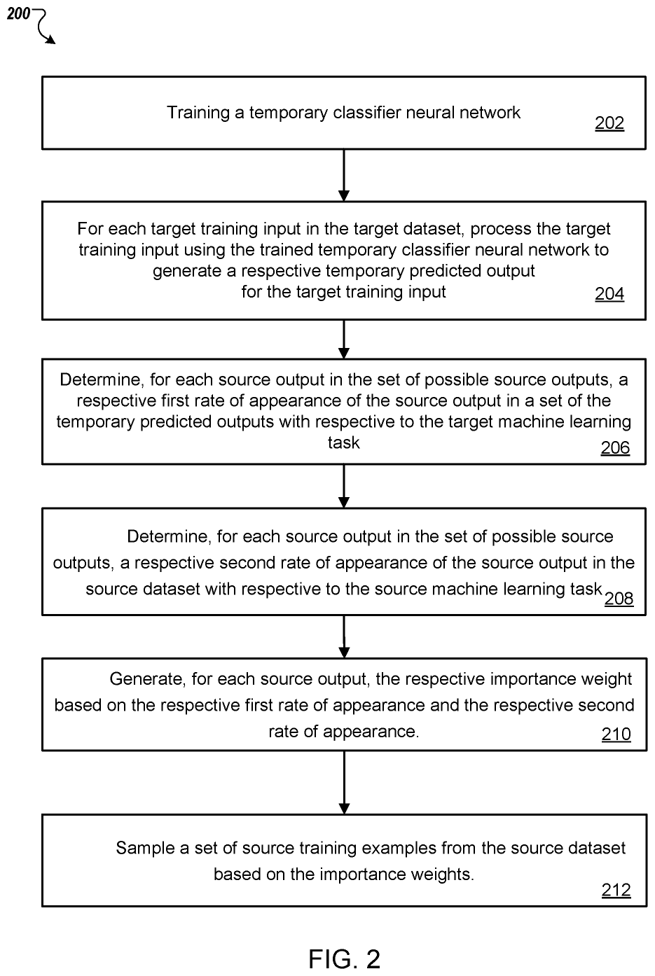

FIG. 2 is a flow diagram of an example process 200 for generating a pre-training dataset. For convenience, the process 200 will be described as being performed by a system of one or more computers located in one or more locations. For example, a neural network system, e.g., the neural network system 100 of FIG. 1, appropriately programmed in accordance with this specification, can perform the process 200.

The system trains a classifier neural network on the source dataset (step 202). The classifier neural network is configured to receive an input and to generate an output that belongs to the set of possible source outputs. The classifier neural network can be the same as the source neural network or different from the source neural network.

For each of the target training inputs in the target dataset, the system processes the target training input using the trained classifier neural network to generate a respective temporary predicted output for the target training input (step 204).

The system determines, for each source output y in the set of possible source outputs, a respective first rate of appearance Pₜ(y) of the source output y in a set of the temporary predicted outputs Pₜ(y) with respect to the target machine learning task (step 206).

The system determines, for each source output in the set of possible source outputs, a respective second rate of appearance Pₛ(y) of the source output in the source dataset with respect to the source machine learning task (step 208).

The system then generates, for each source output, the respective importance weight based on the respective first rate of appearance and the respective second rate of appearance (step 210). In particular, the respective importance weight is the ratio Pₜ(y)/Pₛ(y).

The system generates the pre-training dataset by sampling a set of source training examples from the source dataset based on the importance weights (step 212). In some implementations, the set of source training examples is sampled from the source dataset with replacement. When sampling with replacement, the system samples source training examples at a rate proportional to the importance weights computed before, repeating examples as needed. In some other implementations, the set of source training examples is sampled from the source dataset without replacement. When sampling without replacement, the system avoids selecting each example more than once.

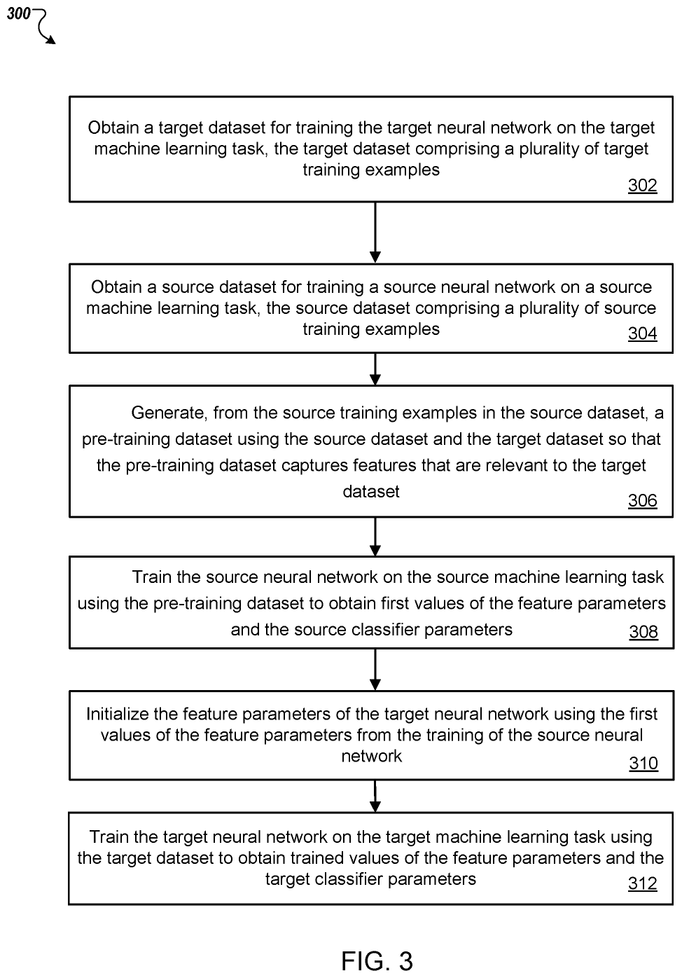

FIG. 3 is a flow diagram of an example process 300 for training a target neural network on a target machine learning task. For convenience, the process 300 will be described as being performed by a system of one or more computers located in one or more locations. For example, a neural network system, e.g., the neural network system 100 of FIG. 1, appropriately programmed in accordance with this specification, can perform the process 300.

The system obtains a target dataset for training the target neural network on the target machine learning task (step 302). The target dataset comprising a plurality of target training examples. Each of the plurality of target training examples includes a target training input and a respective ground-truth target output.

The system obtains a source dataset for training a source neural network on a source machine learning task (step 304). Generally, the source dataset is much larger than the target dataset and is potentially not fully relevant to the target machine learning task. The source dataset includes a plurality of source training examples. Each source training example in the source dataset includes a source training input and a respective ground-truth source output. The respective ground-truth source output belongs to a set of possible source outputs.

The target neural network and the source neural network may have the same architecture but with different parameters. In particular, the target neural network and the source neural network have the same feature neural network layers having features parameters. The target neural network further includes one or more target classification layers having target classification parameters, and the source neural network further includes one or more source classification layers having source classification parameters.

The system generates, from the source training examples in the source dataset, a pre-training dataset using the source dataset and the target dataset so that the pre-training dataset captures features that are relevant to the target dataset (step 306).

In particular, to generate the pre-training dataset, for each source output in the set of possible source outputs, the system generates a respective importance weight based on the source dataset and the target training inputs. The respective importance weight indicates the importance of the source output in training the target neural network. The system generates the pre-training dataset by sampling a set of source training examples from the source dataset based on the importance weights. In some implementations, the set of source training examples is sampled from the source dataset without replacement. In some other implementations, the set of source training examples is sampled from the source dataset with replacement.

To generate, for each source output in the set of possible source outputs, a respective importance weight, the system trains a classifier neural network on the source dataset. The classifier neural network is configured to receive an input and to generate, for the input, an output that belongs to the set of possible source outputs. The classifier neural network can be the same as the source neural network or different from the source neural network. For each target training input in the target dataset, the system processes the target training input using the trained classifier neural network to generate a respective temporary predicted output for the target training input. The system generates, for each source output in the set of possible source outputs, a respective first rate of appearance of the source output in the target machine learning task based on the temporary predicted outputs. The system generates, for each source output in the set of possible source outputs, a respective second rate of appearance of the source output in the source machine learning task based on the source dataset. The system then generates, for each source output, the respective importance weight based on the respective first rate of appearance and the respective second rate of appearance.

The system trains the source neural network on the source machine learning task using the pre-training dataset to obtain first values of the feature layer parameters and the source classification parameters (step 308). In particular, the system adjusts values of the feature layer parameters and the source classifier parameters to optimize a source objective function. The source objective function measures an average performance of the source neural network on the source machine learning task given the source training examples in the pre-training dataset.

The system initializes the feature layer parameters of the target neural network using the first values of the feature layer parameters from the training of the source neural network (step 310).

The system trains the target neural network on the target machine learning task using the target dataset to obtain trained values of the feature layer parameters and the target classifier parameters (step 312). More specifically, the system adjusts values of the feature layer parameters and the target classifier parameters to optimize a target objective function. The target objective function measures an average performance of the target neural network on the target machine learning task given the target training examples in the target dataset.

After training, in some cases, the system may use the trained target neural network to process a new input to generate a new output. In some other cases, the system may provide the trained target neural network to another system that uses the trained target neural network to process a new input to generate a new output.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for training a target neural network on a target machine learning task, the method comprising:
obtaining a target dataset for training the target neural network on the target machine learning task, the target dataset comprising a plurality of target training examples;
obtaining a source dataset for training a source neural network on a source machine learning task, the source dataset comprising a plurality of source training examples;
wherein each of the target neural network and the source neural network has the same feature neural network layers having feature layer parameters, the target neural network further comprises one or more target classification layers having target classification parameters, and the source neural network further comprises one or more source classification layers having source classification parameters;
generating, from the source training examples in the source dataset, a pre-training dataset using the source dataset and the target dataset so that the pre-training dataset captures features that are relevant to the target dataset;
training the source neural network on the source machine learning task using the pre-training dataset to obtain first values of the feature layer parameters and the source classification parameters;
initializing the feature layer parameters of the target neural network using the first values of the feature layer parameters from the training of the source neural network; and
training the target neural network on the target machine learning task using the target dataset to obtain trained values of the feature layer parameters and the target classification parameters.

2. The method of claim 1, wherein each source training example in the source dataset comprises a source training input and a respective ground-truth source output, wherein the respective ground-truth source output belongs to a set of possible source outputs, and
wherein each target training example in the target dataset comprises a target training input and a respective ground-truth target output.

3. The method of claim 2, wherein generating the pre-training dataset using the source dataset and the target dataset comprising:
generating, for each source output in the set of possible source outputs, a respective importance weight based on the source dataset and the target training inputs, the respective importance weight indicating the importance of the source output in training the target neural network; and
generating the pre-training dataset by sampling a set of source training examples from the source dataset based on the importance weights.

4. The method of claim 3, wherein generating, for each source output in the set of possible source outputs, a respective importance weight based on the source dataset and the target training inputs comprising:
training a classifier neural network on the source dataset, wherein the classifier neural network is configured to receive an input and to generate for the input a respective output that belongs to the set of possible source outputs.

5. The method of claim 4, wherein generating, for each source output in the set of possible source outputs, a respective importance weight based on the source dataset and the target training inputs comprising:
for each target training input in the target dataset, processing the target training input using the trained classifier neural network to generate a respective temporary predicted output for the target training input;
determining, for each source output in the set of possible source outputs, a respective first rate of appearance of the source output in a set of the temporary predicted outputs with respective to the target machine learning task;
determining, for each source output in the set of possible source outputs, a respective second rate of appearance of the source output in the source dataset with respective to the source machine learning task; and
generating, for each source output, the respective importance weight based on the respective first rate of appearance and the respective second rate of appearance.

6. The method of claim 3, wherein the set of source training examples is sampled from the source dataset with replacement.

7. The method of claim 3, wherein the set of source training examples is sampled from the source dataset without replacement.

8. The method of claim 1, wherein training the source neural network on the source machine learning task using the pre-training dataset to obtain the first values of the feature layer parameters and the source classification parameters comprises:
adjusting values of the feature layer parameters and the source classification parameters to optimize a source objective function, wherein the source objective function measures an average performance of the source neural network on the source machine learning task given the source training examples in the pre-training dataset.

9. The method of claim 1, wherein training the target neural network on the target machine learning task using the target dataset to obtain trained values of the feature layer parameters and the target classification parameters comprises:
adjusting values of the feature layer parameters and the target classification parameters to optimize a target objective function, wherein the target objective function measures an average performance of the target neural network on the target machine learning task given the target training examples in the target dataset.

10. The method of claim 1, wherein the source learning task and the target machine learning task are different image classification tasks.

11. The method of claim 1, further comprising:
using the trained target neural network to process a new input to generate a new output.

12. The method of claim 1, further comprising:
providing the trained target neural network to a system that uses the trained neural network to process a new input to generate a new output.

13. A system comprising one or more computers and one or more storage devices storing instructions that, when executed by the one or more computers, cause the one or more computers to perform operations comprising:
obtaining a target dataset for training the target neural network on the target machine learning task, the target dataset comprising a plurality of target training examples;
obtaining a source dataset for training a source neural network on a source machine learning task, the source dataset comprising a plurality of source training examples;
wherein each of the target neural network and the source neural network has the same feature neural network layers having feature layer parameters, the target neural network further comprises one or more target classification layers having target classification parameters, and the source neural network further comprises one or more source classification layers having source classification parameters;
generating, from the source training examples in the source dataset, a pre-training dataset using the source dataset and the target dataset so that the pre-training dataset captures features that are relevant to the target dataset;
training the source neural network on the source machine learning task using the pre-training dataset to obtain first values of the feature layer parameters and the source classification parameters;
initializing the feature layer parameters of the target neural network using the first values of the feature layer parameters from the training of the source neural network; and
training the target neural network on the target machine learning task using the target dataset to obtain trained values of the feature layer parameters and the target classification parameters.

14. The system of claim 13, wherein each source training example in the source dataset comprises a source training input and a respective ground-truth source output, wherein the respective ground-truth source output belongs to a set of possible source outputs, and
wherein each target training example in the target dataset comprises a target training input and a respective ground-truth target output.

15. The system of claim 14, wherein generating the pre-training dataset using the source dataset and the target dataset comprising:
generating, for each source output in the set of possible source outputs, a respective importance weight based on the source dataset and the target training inputs, the respective importance weight indicating the importance of the source output in training the target neural network; and
generating the pre-training dataset by sampling a set of source training examples from the source dataset based on the importance weights.

16. The system of claim 15, wherein generating, for each source output in the set of possible source outputs, a respective importance weight based on the source dataset and the target training inputs comprising:
training a classifier neural network on the source dataset, wherein the classifier neural network is configured to receive an input and to generate an output that belongs to the set of possible source outputs.

17. The system of claim 16, wherein generating, for each source output in the set of possible source outputs, a respective importance weight based on the source dataset and the target training inputs comprising:
for each target training input in the target dataset, processing the target training input using the trained classifier neural network to generate a respective temporary predicted output for the target training input;
determining, for each source output in the set of possible source outputs, a respective first rate of appearance of the source output in the target machine learning task based on the temporary predicted outputs;
determining, for each source output in the set of possible source outputs, a respective second rate of appearance of the source output in the source machine learning task based on the source dataset; and
generating, for each source output, the respective importance weight based on the respective first rate of appearance and the respective second rate of appearance.

18. The system of claim 15, wherein the set of source training examples is sampled from the source dataset with replacement.

19. The system of claim 15, wherein the set of source training examples is sampled from the source dataset without replacement.

20. One or more non-transitory computer-readable storage media encoded with instructions that, when executed by one or more computers, cause the one or more computers to perform operations comprising:
obtaining a target dataset for training the target neural network on the target machine learning task, the target dataset comprising a plurality of target training examples;
obtaining a source dataset for training a source neural network on a source machine learning task, the source dataset comprising a plurality of source training examples;
wherein each of the target neural network and the source neural network has the same feature neural network layers having feature layer parameters, the target neural network further comprises one or more target classification layers having target classification parameters, and the source neural network further comprises one or more source classification layers having source classification parameters;
generating, from the source training examples in the source dataset, a pre-training dataset using the source dataset and the target dataset so that the pre-training dataset captures features that are relevant to the target dataset;
training the source neural network on the source machine learning task using the pre-training dataset to obtain first values of the feature layer parameters and the source classification parameters;
initializing the feature layer parameters of the target neural network using the first values of the feature layer parameters from the training of the source neural network; and
training the target neural network on the target machine learning task using the target dataset to obtain trained values of the feature layer parameters and the target classification parameters.
